(19) United States
(12) Patent Application Publication
(10) Pub. No.: US 2013/0315140 A1
(43) Pub. Date: Nov. 28, 2013

(54) RECEPTION QUALITY ASSESSMENT

(71) Applicant: Canon Kabushiki Kaisha, Tokyo (JP)

(72) Inventors: Mickaël LORGEOUX, Rennes (FR); Mounir ACHIR, Chantepie (FR)

(73) Assignee: Canon Kabushiki Kaisha, Tokyo (JP)

(21) Appl. No.: 13/893,872

(22) Filed: May 14, 2013

(30) Foreign Application Priority Data
May 16, 2012 (GB) 1208626.0

(51) Int. Cl. H04W 52/26

(52) U.S. Cl. CPC H04W 52/26
USPC 370/328

(57) ABSTRACT

A method for assessing reception quality of a common transmission by a set of receivers comprising deriving a reception quality for different combinations of the set, and assessing each against a threshold which varies according to the number of receivers in the respective combination. A single assessment of quality can be produced which takes into account multiple different receivers, and multiple different combinations of such receivers. Such assessment allows transmission power and/or the number of active receivers to be set according to a given reception criteria.

### CROSS-REFERENCE TO RELATED APPLICATIONS

This application claims the benefit under 35 U.S.C. §119(a)-(d) of United Kingdom Application No. 1208626.0, filed on May 16, 2012 and entitled “A method and device for encoding and decoding a video signal”. The above cited patent application is incorporated herein by reference in its entirety.

### FIELD OF THE INVENTION

The present invention relates to assessment of reception quality in a receiver arrangement having multiple inputs and providing a single output. The invention is particularly, but not exclusively, concerned with the setting or adjusting of transmission power according to an assessment of reception quality in a wireless network system.

### BACKGROUND OF THE INVENTION

The present invention finds particular application in the wireless transmission of uncompressed High Definition (HD) video or image data for applications requiring low Bit Error Rate (BER) and low latency transmission. More specifically, this invention has been conceived in consideration of a 60 GHz wireless network system using a single moving emitter and several fixed receivers, said receivers being connected to a system controller device.

A wireless network system using the millimeter wave frequency band (60 GHz) is well adapted to the transmission of uncompressed HD video or image data. An advantageous characteristic of a wireless network using 60 GHz frequency band is a large available bandwidth. This large bandwidth allows very high data rate transmission (>3 Gbps).

Another characteristic of a wireless network using 60 GHz frequency band is its sensibility to masking phenomenon. Some static or moving obstacles such as objects, structures, people etc. can interrupt or degrade the communication path and cause transmission errors.

To mitigate against transmission errors, a 60 GHz wireless network system is proposed which uses a multi-reception technique to create spatial diversity and a Multi-Reception Error Correcting Code to reach the BER and low latency. The 60 GHz wireless network system proposed forms a network cell. Practically, several network cells can be used simultaneously within the same area. For example, these networks cells can be used in an industrial environment.

The use of several network cells simultaneously in the same vicinity can lead to Radio Frequency (RF) interference problems in between adjacent network cells. Moreover, a network cell used in an industrial environment is typically surrounded by a lot of metallic surfaces. These metallic surfaces create a 60 GHz wireless channel with a lot of multi-paths which can disturb the radio communications.

To mitigate the RF interference problems in between adjacent network cells and to mitigate the multi-path within a network cell, a solution is to manage the transmission power of the emitter node appropriately.

US20040259584A1 proposes a transmission power control method in a point to point wireless communication system. In this document the transmission power is controlled to match a reception quality target. The signal reception quality is measured on the receiver side (measured Signal-to-Interference-Ratio) and compared to a target reception quality (target Signal-to-Interference-Ratio). A Transmission Power Control (TPC) is generated or adjusted accordingly.

It is an object of certain aspects of the present invention to provide an improved transmission power control method for a single emitter, multiple receiver wireless communication system, to mitigate against RF interference between adjacent network cells, while maintaining appropriate reception quality.

It is further an object of certain aspects of the invention to provide an improved method for assessing reception quality.

### BRIEF SUMMARY OF THE INVENTION

Accordingly, in a first aspect the present invention provides a method for assessing reception quality of a common transmission by a set of receivers, said method comprising deriving a reception quality value for each of a plurality of different combinations of said set, assessing each determined value against a threshold which varies according to the number of receivers in the respective combination, and determining whether at least one combination exceeds said threshold.

In this way, a single assessment of quality can be produced which takes into account multiple different receivers capable of receiving the same data, and multiple different combinations of such receivers. The method is particularly advantageous in allowing combinations of different numbers of receivers to be combined in a single assessment, by adapting the threshold value accordingly. Consideration of such combinations in parallel in this way allows transmission power and the number of active receivers to be set simultaneously according to a given reception criteria, as will be explained below.

In a preferred embodiment, the result of the determination is used to control the transmission power of said transmission. Either the result or a signal generated in response to the result is communicated to the transmission source to effect such a change for example.

Control of transmission power may be performed iteratively, by continuously assessing reception quality and adjusting transmission power in response to the assessment until a satisfactory result is achieved. The method may involve iteratively increasing transmission power by a fixed amount in response to a negative determination, until a positive determination is achieved, or conversely iteratively decreasing transmission power by a fixed amount in response to a positive determination until a negative determination is achieved. In each of these two cases the transmission power will typically be set at a lower and upper initial value respectively. In the case of iteratively decreasing power, the power setting of the penultimate iteration is typically selected.

It should be noted that a reception quality value can be a positive quality assessment (such as SNR for example) where a higher numerical value represents a higher quality, or a negative quality assessment (such as an error rate for example), where a higher numerical value represent a lower quality.

This will be evident to the skilled reader, and determining whether or not such a value exceeds a quality threshold will be interpreted accordingly, including a case where a numerical value less than said threshold results in said (quality) threshold being exceeded.

For each combination of receivers, copies of the same data but received via different receivers are preferably combined, and in one example reconstructed data blocks are preferably formed from combinations of sub blocks of copies of the same data block from respective receivers. Other possible combination techniques include a majority decision data combination for example, which can be performed on a bit by bit basis.

A reception quality value is typically determined by assessing the number and/or distribution of transmission errors in respective copies of data received via the different receivers, and hence transmission paths. Forming different combinations of copies of data in parallel contributes towards this, as described above.

In certain embodiments, a reception quality value is determined by means of an error correction code, preferably, but not necessarily, the false check rate (FCR) of a combination of receivers.

As noted above, this aspect is advantageous in allowing combinations of different numbers of receivers to be combined in a single assessment. This provides further adaptability in terms of distribution between channels.

The use of an adaptive threshold enables combinations of different numbers of receivers to be considered simultaneously in a meaningful manner. Preferably a parameter is used which can be expressed as a function of bit error rate (BER), and more preferably different functions can be provided, or a variation made to the same function to account for different numbers of receivers. In this way, equivalence of a common target BER between combinations of different numbers of receivers can be maintained.

At each thresholding or comparison step, a threshold value can be calculated dynamically, or can be stored in advance and retrieved form a memory for example.

According to a further aspect the invention provides a system controller for assessing reception quality of a common transmission by a set of receivers comprising an input unit configured to receive from each of a set of receivers data corresponding to said common transmission; a data processing unit configured to combine, for each of a plurality of different combinations of receivers, data from the respective receivers, and calculate a quality parameter for each said combination based on said combined data; a reference unit configured to provide a reference value which varies according to the number of receivers in a respective combination; and an output unit configured to determine if at least one calculated quality parameter exceeds the relevant reference value, and to output an indication of reception quality for said set, based on said determination.

According to a still further aspect of the invention, there is provided a wireless network system comprising a transmitter node, a plurality of receiver nodes, and a system controller as set out above.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

The invention extends to methods, apparatus and/or use substantially as herein described with reference to the accompanying drawings. Any feature in one aspect of the invention may be applied to other aspects of the invention, in any appropriate combination. In particular, features of method aspects may be applied to apparatus aspects, and vice versa. Furthermore, features implemented in hardware may generally be implemented in software, and vice versa. Any reference to software and hardware features herein should be construed accordingly.

### BRIEF DESCRIPTION OF THE DRAWINGS

Preferred features of the present invention will now be described, purely by way of example, with reference to the accompanying drawings in which:

FIG. 1 shows an arrangement of network cells, each cell having a transmitter node and multiple receiver nodes;

FIG. 2 shows the detailed architecture of a cell of FIG. 1;

FIG. 3 illustrates a multi-rx ECC module and the FCR quality parameter of embodiments of the invention;

FIG. 4 represents a method of determining transmission power using a multi-rx quality assessment;

FIG. 5 represents a derivative of the method of FIG. 4;

FIG. 6 shows a relationship obtained by simulation between FCR and BER for different numbers of receivers.

### DETAILED DESCRIPTION OF THE PREFERRED EMBODIMENTS

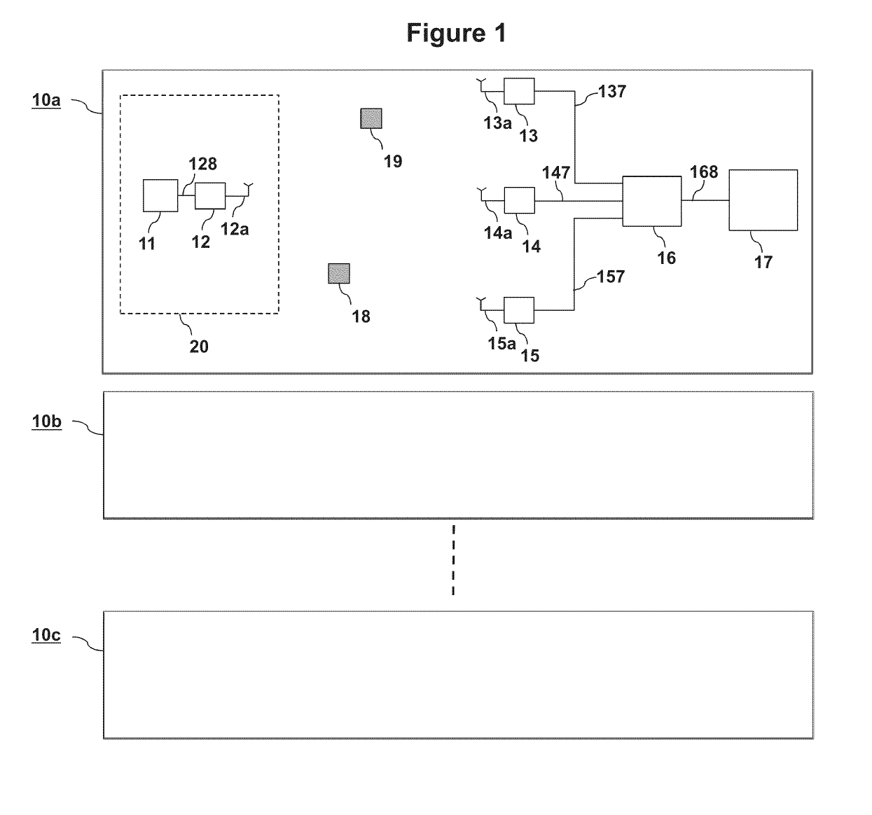

FIG. 1 illustrates several network cells 10a, 10b and 10c that are placed close to each other in an industrial environment, for example in a factory. The networks cells 10a, 10b and 10c are identical, so only the network cell 10a will be described below.

In the network cell 10a, the node 12 is called emitter node, the nodes 13, 14, 15 are called receivers nodes and the node 16 is called system controller node. These nodes names correspond to the direction of the main communication, called downlink communication, which takes place within the network cell 10a. This main downlink communication is used for wireless transmission of HD video or image data for example, from emitter node 12 to system controller node 16 through the receiver nodes 13, 14 and 15. This main downlink communication used around 90% of the total bandwidth of the network cell 10a in this embodiment.

A secondary communication, called uplink communication, takes place within the network cell 10a from the wireless controller node 16 to the receiver nodes 13, 14 or 15, or from the wireless controller 16 to the emitter node 12 through one or all receiver nodes 13, 14 and 15. This secondary uplink communication is used for transmission of control/command data from system controller 16 to receiver nodes 13, 14 or 15 or from system controller node 16 to emitter node 12 through one or all receiver nodes 13, 14 and 15; as first example, this secondary uplink communication is used to put a receiver node in standby mode; as second example, this secondary uplink communication is used to update the transmission power of the emitter node 12. This secondary uplink communication used around 10% of the total bandwidth of the network cell 10a in this embodiment.

The emitter node 12 is connected to an HD video or image data source device 11 through a wired interface 128. The source device 11 can be an HD digital camera, an HD digital camcorder or another such device. The wireless emitter node 12 processes the HD video or image data, and sends the processed data wirelessly through its antenna 12a. The emitter node 12 can send the processed data from several different positions within the area 20.

The data sent by the emitter node 12 is received by the receiver nodes 13, 14 and 15 respectively through their antennas 13a, 14a and 15a. The receiver nodes 13, 14 and 15 are located in different positions to create spatial diversity. In this embodiment, 3 receiver nodes are used but other configurations could be used, for example configurations with 2, 4, 5 or 6 receiver nodes could be used.

Items 18 and 19 represent obstacles that can be positioned between emitter node 12 and receiver nodes 13, 14 and 15. These obstacles can be metallic objects, humans, structures etc. Depending on the position of the emitter 12 within the area 20 and depending on the position of the obstacles 18 and 19, one or more line of sight communication path between the emitter node 12 and the receiver nodes 13, 14 and 15 can be disrupted or blocked. As a result, the receiver nodes 13, 14 and 15 may have different reception quality, i.e. different BER.

Receiver nodes 13, 14 and 15 process the data received from the emitter node 12 and send the processed data to the system controller 16 respectively through the wired interfaces 137, 147 and 157. The system controller 16 receives the 3 received copies representing the same original data from the receiver nodes 13, 14 and 15. The system controller node 16 includes a Multi-rx Error Correction Code (ECC) module and performs an assessment of reception quality (to be described in greater detail below) which in turn enables an appropriate (minimum) RF transmission power to be used by the emitter node 12. Additionally or alternatively, the minimum number of required receivers among the receivers 13, 14 and 15 can also be determined in certain embodiments. The system controller 16 then sends the decoded HD video or image data to the sink device 17 through a wire interface 168. The sink device 17 can be an HD video/image display, a Personal Computer or other device.

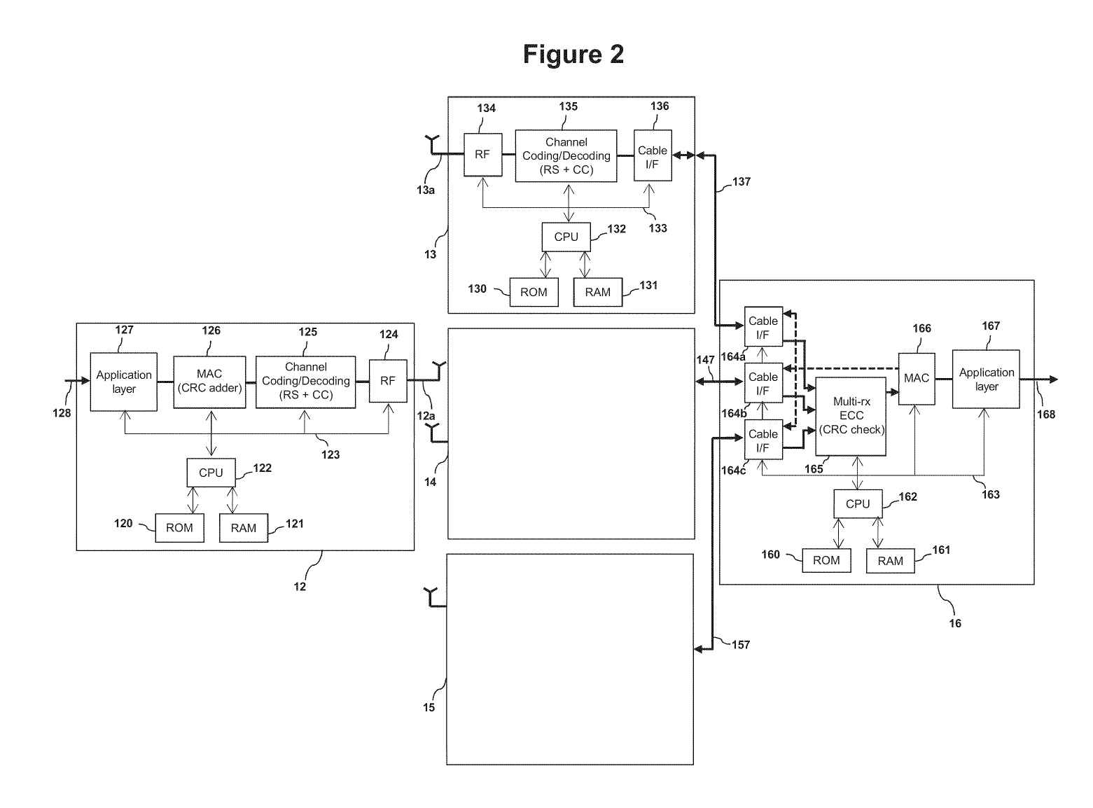

FIG. 2 shows the functional block diagrams of emitter node 12, receiver nodes 13, 14 and 15 and system controller 16. The operation of the emitter node 12 is described below, firstly in case of downlink communication and secondly in case of uplink communication.

In case of downlink communication, the emitter node 12 is connected to an HD video or image source device 11 (shown in FIG. 1) through a wire interface 128. The wire interface 128 can be an HDMI interface, a Camera Link interface or other. The source device 11 (shown in FIG. 1) is connected to the module 127 of the node 12 via the wire interface 128. The module 127 is the Application layer module of the emitter node 12. The module 127 retrieves the HD video or image content received from source device 11 (shown in FIG. 1) and formats these HD video or image data to be processed by MAC layer module 126. The formatted data are then sent to the MAC layer module 126.

The MAC module 126 receives the formatted data sent by the Application layer 127. The MAC module 126 builds the MAC data packets by adding header data to the received formatted data and by adding ECC redundancy bits.

For example, the addition of ECC redundancy bits consists of performing CRC encoding on portions of data. For example, each 32 Bytes of data, the MAC module 126 computes and adds a 4 Bytes CRC to form an encoded data block. A MAC data packet consists of several encoded data blocks. Then the MAC data packets are sent to the Channel Coding module 125.

The Channel Coding module 125 receives the MAC data packets and performs channel encoding function. For example, the module 125 encodes the MAC data packets using a Reed Solomon (216/224) encoder and a convolutive encoder (2/3). The output of Channel Coding module 125 is connected to the RF transceiver module 124. The RF transceiver 124 receives the MAC data packets after channel encoding by the module 125. Then the RF transceiver 124 builds the radio packets by modulating the received data and by adding a preamble pattern. Then the RF transceiver 124 performs the remaining functions needed for the transmission of radio packets on the 60 GHz radio channel through the antenna 12a.

In case of uplink communication, the emitter node 12 receives radio packets from receiver nodes 13, 14 or 15. These radio packets embed control/command data sent by the system controller node 16 and forwarded by one or several receiver nodes 13, 14 or 15.

In the emitter node 12, the RF transceiver 124 performs the function needed for the reception of radio packets on the 60 GHz radio channel through the antenna 12a. After the reception of radio packets, the RF transceiver 124 removes the preamble pattern from the radio packet and demodulates the received data. The demodulated data are then sent to the channel decoding module 125. The channel decoding module 125 receives the demodulated data and performs channel decoding. For example, the module 125 decodes the demodulated data using a Viterbi decoder (2/3) and a Reed Solomon (216/224) decoder. Then, the Channel Decoding module 125 sends the retrieved MAC data packets to the MAC module 126.

The MAC module 126 processes the received MAC data packets to retrieve the control/command data sent by the system controller node 16. Then, the control/command data are stored within internal registers of the MAC module 126 to be further processed by the CPU 122. An example of control/command data sent by the system controller node 16 to the emitter node 12 is the RF transmission power value to be used by the emitter node 12.

The CPU module 122 of the emitter node 12 is connected to a ROM 120 and a RAM 121. The ROM 120 contains a software program which can be used, when executed by the CPU 122 (using the RAM 121), to implement certain aspects of the present invention. The RAM 121 is used for the execution by the CPU 122 of the above-mentioned software program and for the processing of the different tasks performed by the CPU 122.

The CPU 122 is connected to the modules 127, 126, 125 and 124 via a bi-directional address/data bus 123. Amongst other things, this connection permits to the CPU 122 to initialize and configure the modules 127, 126, 125 and 124 at system start-up. This connection also permits to the CPU 122 to read the updated value of RF transmission power stored within internal registers of MAC module 126. Then the CPU 122 provides this updated RF transmission power value to the RF transceiver 124 to be used for the next transmission of radio packets.

The operation of the receiver nodes 13, 14 and 15 is described below, firstly in case of downlink communication and secondly in case of uplink communication. In case of downlink communication, the receiver nodes 13, 14 and 15 receive the radio packets sent by the emitter node 12 respectively through their antenna 13a, 14a and 15a. The receiver nodes 13, 14 and 15 have the same functional bloc diagram, as a result only receiver node 13 will be described here.

In the receiver node 13, the RF transceiver 134 performs the function needed for the reception of radio packets on the 60 GHz radio channel through the antenna 13a. After the reception of radio packets, the RF transceiver 134 removes the preamble pattern from the radio packet and demodulates the received data. The demodulated data are then sent to the channel decoding module 135. The channel decoding module 135 receives the demodulated data and performs channel decoding function. For example, the module 135 decodes the demodulated data using a Viterbi decoder (2/3) and a Reed Solomon (216/224) decoder. Then the channel decoding module 135 sends the retrieved MAC data packets to the Cable Interface module 136.

The Cable Interface module 136 receives the MAC data packets from the Channel Decoding module 135. The module 136 formats the MAC data packets to transmit them to the system controller 16 via the wire link 137. The wire link 137 is typically a serial wire link able to support data rate up to several Gbps.

In case of uplink communication, the receiver node 13 receives MAC data packets from the system controller 16 through the wire link 137. These MAC data packets embed control/command data either for the emitter node 12 or for the receiver node 13. The cable interface module 136 of the receiver node 13 receives the MAC data packets sent by the system controller node 16.

When the received MAC data packets embed control/command data for the emitter node 12, the cable interface module 136 provides the MAC data packet to the channel coding module 135. The channel coding module 135 receives the MAC data packets and performs channel encoding function. For example, the module 135 encodes the MAC data packets using a Reed Solomon (216/224) encoder and a convolutive encoder (2/3). The output of channel coding module 135 is connected to the RF transceiver module 134. The RF transceiver 134 receives the MAC data packet after channel encoding by the module 135. Then the RF transceiver 134 builds the radio packets by modulating the received data and by adding a preamble pattern. Then the RF transceiver 134 performs the remaining functions needed for the transmission of radio packets on the 60 GHz radio channel through the antenna 13a.

When the received MAC data packets embed control/command data for the receiver node 13, the cable interface module 136 processes the received MAC data packets to retrieve the control/command data sent by the system controller node 16. Then, the control/command data are stored within internal registers of the cable interface module 136 to be further processing by the CPU 132. An example of control/command data sent by the system controller node 16 to the receiver node 13 is the standby mode information.

The CPU module 132 of the receiver node 13 is connected to a ROM 130 and a RAM 131. The ROM 130 contains a software program which can be used, when executed by the CPU 132 (using the RAM 131), to implement the present invention. The RAM 131 is used for the execution by the CPU 132 of the above-mentioned software program and for the processing of the different tasks performed by the CPU 132. The CPU 132 is connected to the modules 136, 135 and 134 via a bi-directional address/data bus 133. Amongst other things, this connection permits to the CPU 132 to initialize and configure the modules 136, 135 and 134 at system start-up.

This connection also permits to the CPU 132 to read the standby mode information stored within internal registers of cable interface module 136. Depending on the value of the standby mode information, the CPU 132 will either put the receiver node 13 in standby mode or output the receiver node 13 from standby mode.

The operation of the system controller node 16 is described below, firstly in case of downlink communication and secondly in case of uplink communication. In case of downlink communication, the system controller 16 receives 3 copies of each formatted MAC data packet from the 3 receiver nodes 13, 14 and 15 respectively via the wire link 137, 147 and 157. The first copy of formatted MAC data packet is transmitted by the receiver node 13 and received by the system controller 16 through its Cable Interface module 164a. The Cable Interface module 164a processes the received data and sends the first copy of MAC data packet to the module 165. The second copy of formatted MAC data packet is transmitted by the receiver node 14 and received by the system controller 16 through its Cable Interface module 164b. The Cable Interface module 164b processes the received data and sends the second copy of MAC data packet to the module 165. The third copy of formatted MAC data packet is transmitted by the receiver node 15 and received by the system controller 16 through its Cable Interface module 164c. The Cable Interface module 164c processes the received data and sends the third copy of MAC data packet to the module 165.

The module 165 is a Multi-rx ECC module. This module applies a Multi-Rx error correcting code on the 3 copies received from the receiver nodes 13, 14 and 15 and typically allows the BER required by the application to be met. The computation of a quality parameter for each combination of receivers is also performed by this module in the present example. These quality parameters can in turn be used to determine the minimum RF transmission power to be used by the emitter node 12, and/or in some embodiment the smallest number of required receivers among the receivers 13, 14 and 15.

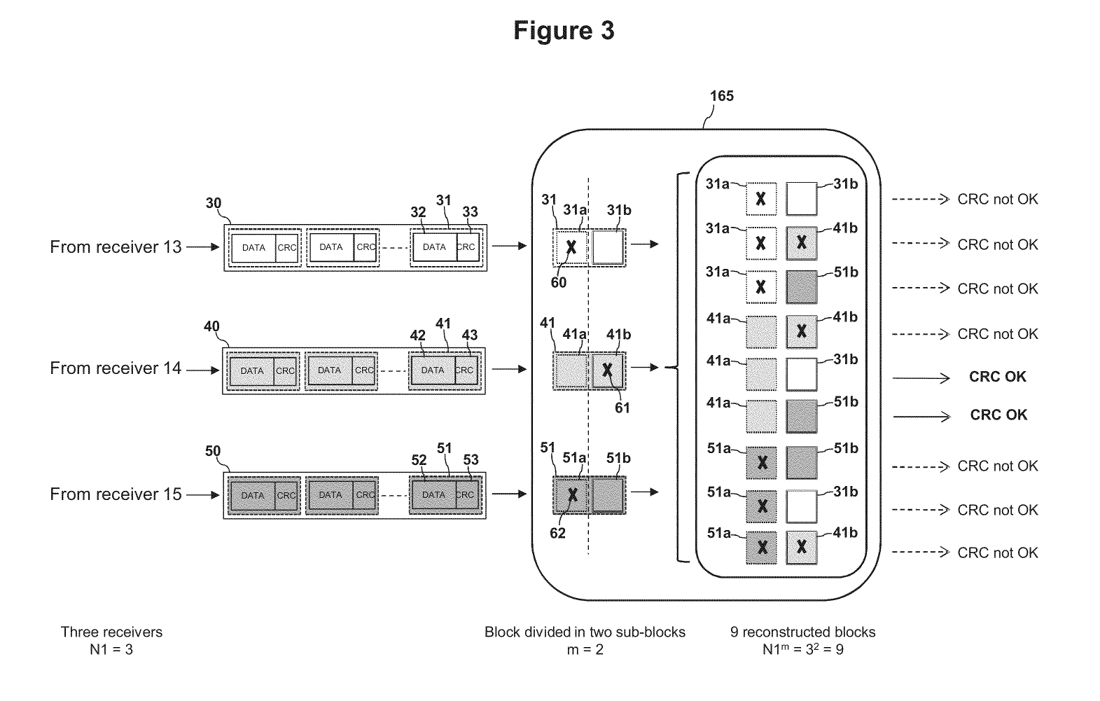

An example of a Multi-rx ECC module 165 and its operation is described in greater detail below in relation to FIG. 3.

After decoding, the module 165 selects the first reconstructed copies that satisfied the CRC check and provides it to the MAC module 166. The MAC module 166 receives the reconstructed copies outputted by the module 165 and re-constructs each MAC data packet. Then the MAC module 166 retrieves the HD video or image data by removing the header information attached to the MAC data packets. Next, the MAC module 166 provides the HD video or image data to the Application layer module 167.

The Application layer 167 receives the HD video or image data from the MAC layer 166 and re-builds the HD video or image content. The HD video or image content is then sent to the sink device 17 (shown in FIG. 1) through the wire interface 168. The wire interface 168 can be an HDMI interface, a Camera Link interface or else.

In case of uplink communication, the system controller node 16 sends control/command data either to the emitter node 12 through one or all receiver nodes 13, 14 or 15, or to the receiver nodes 13, 14 or 15.

As part of one operating method, the MAC module 166 builds MAC data packets which contain updated value of RF transmission power and sends these MAC data packets to the emitter node 12 through one or all receiver nodes 13, 14 or 15. This task is done iteratively by the MAC module 166 up to the determination of minimum RF transmission power value to be used by the emitter node 12. Additionally or alternatively, the combination of minimum number of receiver nodes necessary to reach the BER required by the application can be determined. Then the MAC module 166 builds and sends MAC data packets which contain control/command data to put in standby mode the receiver nodes out of the determined combination.

The CPU module 162 of the system controller 16 is connected to a ROM 160 and a RAM 161. The ROM 160 contains a software program which can be used, when executed by the CPU 162 (using the RAM 161), to implement the present invention. The RAM 161 is used for the execution by the CPU 162 of the above-mentioned software program and for the processing of the different tasks performed by the CPU 162. The CPU 162 is connected to the modules 167, 166, 165, 164a, 164b, 164c via a bi-directional address/data bus 163. This connection permits also to the CPU 162 to initialize and configure the modules 167, 166, 165, 164a, 164b, 164c at system start-up.

FIG. 3 describes the Multi-rx ECC module and the FCR quality parameter used in a preferred embodiment of the invention. The operation of the preferred Multi-rx ECC module is described below.

The preferred Multi-rx ECC module 165 is described here by considering 3 receivers (N1=3) and a division of copies of an encoded data block into 2 sub-blocks (m=2). These values, N1=3 and m=2, are not limitative and other values can be used.

The Multi-rx ECC module 165 receives the 3 copies 30, 40 and 50 of a MAC data packet respectively from the 3 receiver nodes 13, 14 and 15. The MAC data packet consists of several encoded data blocks. The copy 30 of the MAC data packet consists of several encoded data blocks identical in format to the encoded data block 31. The encoded data block 31 is made of a data part 32 and a CRC part 33. For example the size of the data part 32 is 32 Bytes and the size of CRC part 33 is 4 Bytes. Copies of the MAC data packet 40 and 50 have a similar structure as illustrated.

The 3 copies of each encoded data block within a MAC data packet are inputted and processed in parallel within the Multi-rx ECC module 165.

Firstly, the module 165 performs a division of each copy of an encoded data block into 2 sub-blocks. The copy 31 of an encoded data block is divided into 2 sub-blocks 31a and 31b of equal size in this embodiment. The copy 41 of an encoded data block is divided into 2 sub-blocks 41a and 41b of equal size. The copy 51 of an encoded data block is divided into 2 sub-blocks 51a and 51b of equal size. In alternative embodiments different numbers of sub blocks, and unequal size sub blocks may be used.

The cross 60 within the sub-block 31a of copy 31 of an encoded data block represents an error introduced during the wireless transmission between the emitter node 12 (shown in FIG. 1) and the receiver node 13 (shown in FIG. 1). As a result, the copy 31 cannot be decoded successfully as received from receiver node 13. The cross 61 within the sub-block 41b of copy 41 of an encoded data block represents an error introduced during the wireless transmission between the emitter node 12 (shown in FIG. 1) and the receiver node 14 (shown in FIG. 1). As a result, the copy 41 cannot be decoded successfully as received from receiver node 14. The cross 62 within the sub-blocks 51a of copy 51 of an encoded data block represents errors introduced during the wireless transmission between the emitter node 12 (shown in FIG. 1) and the receiver node 15 (shown in FIG. 1). As a result, the copy 51 cannot be decoded successfully as received from receiver node 15.

Secondly, the module 165 concatenates of the various sub-blocks to build N1^{m}=3²=9 reconstructed data blocks. Each reconstructed data block is therefore formed from a group of sub blocks of data corresponding to the same original data (ie copies of the same data) but received via different receivers. The first reconstructed data block is built by concatenating sub-blocks 31a and 31b, the second reconstructed data block is built by concatenating sub-blocks 31a and 41b, the third reconstructed data block is built by concatenating sub-blocks 31a and 51b, and so on until all combinations are accounted for.

The module 165 then performs in parallel a CRC check on each of the 9 reconstructed data blocks. Finally, the module 165 selects a reconstructed data block that satisfied the CRC check and provides it to the MAC module 166 (shown in FIG. 2).

The False Check Rate (FCR) is an example of a metric indicative of the quality of the decoding, i.e. indicative of the quality of the point to multi-point communication, of the preferred Multi-rx ECC module 165. The FCR metric is defined as the ratio between the number of false CRC checks and the total number of checks at the output of the preferred Multi-rx ECC module 165.

Therefore, for any one given combination of receivers (eg receiver 14 and receiver 15) N^{m} combinations of sub blocks are possible, resulting in N^{m} reconstructed blocks (4 possible reconstructed blocks in the present example). The FCR for this combination (or receivers) can then be determined by considering the number (out of 4 in this case) of reconstructed blocks which give rise to a false CRC check.

In reference to the FIG. 3 describing the preferred Multi-rx ECC module 165, a FCR metric can be computed for each combination of N1−x (with x ε [0 to N1−1]) receivers. In this example, 7 combinations of receivers are possible: 1 combination of 3 receivers exists. This combination associates the receiver nodes 13, 14 and 15. 3 combinations of 2 receivers exist. These combinations associate respectively the receiver nodes 13 and 14, the receiver nodes 14 and 15, the receiver nodes 13 and 15. 3 combinations of 1 receiver exist. These combinations associate respectively the receiver node 13, the receiver node 14, the receiver node 15.

To compute a FCR metric for each combination of receivers, it is necessary to establish different combinations of reconstructed data blocks corresponding to the different combination of received copies, i.e. of receivers. The combination of reconstructed data blocks corresponding to the combination of 3 receivers (13,14,15) gathers the 9 reconstructed data blocks (31a;31b), (31a;41b), (31a;51b), (41a;41b), (41a;31b), (41a;51b), (51a;51b), (51a;31b) and (51a;41b). The combination of reconstructed data blocks corresponding to the combination of 2 receivers (13,14) gathers the 4 reconstructed data blocks (31a;31b), (31a;41b), (41a;41b) and (41a;31b). The combination of reconstructed data blocks corresponding to the combination of 2 receivers (14,15) gathers the 4 reconstructed data blocks (41a;41b), (41a;51b), (51a;51b) and (51a;41b). The combination of reconstructed data blocks corresponding to the combination of 2 receivers (13,15) gathers the 4 reconstructed data blocks (31a;31b), (31a;51b), (51a;51b) and (51a;31b). The combination of reconstructed data blocks corresponding to the combination of 1 receiver (13) gathers the reconstructed data blocks (31a;31b). The combination of reconstructed data blocks corresponding to the combination of 1 receiver (14) gathers the reconstructed data blocks (41a;41b). The combination of reconstructed data blocks corresponding to the combination of 1 receiver (15) gathers the reconstructed data blocks (51a;51b).

Then for a given combination of reconstructed data blocks, the FCR metric is computed by calculating the ratio between the number of false CRC check and the total number of check for said combination at the output of the preferred Multi-rx ECC module.

For example in FIG. 3, for the combination of reconstructed data blocks corresponding to the combination of 3 receivers (13,14,15), the instantaneous value of FCR metric is 7/9. Another example on FIG. 3, for the combination of reconstructed data blocks corresponding to the combination of 2 receivers (14,15), the instantaneous value of FCR metric is ¾.

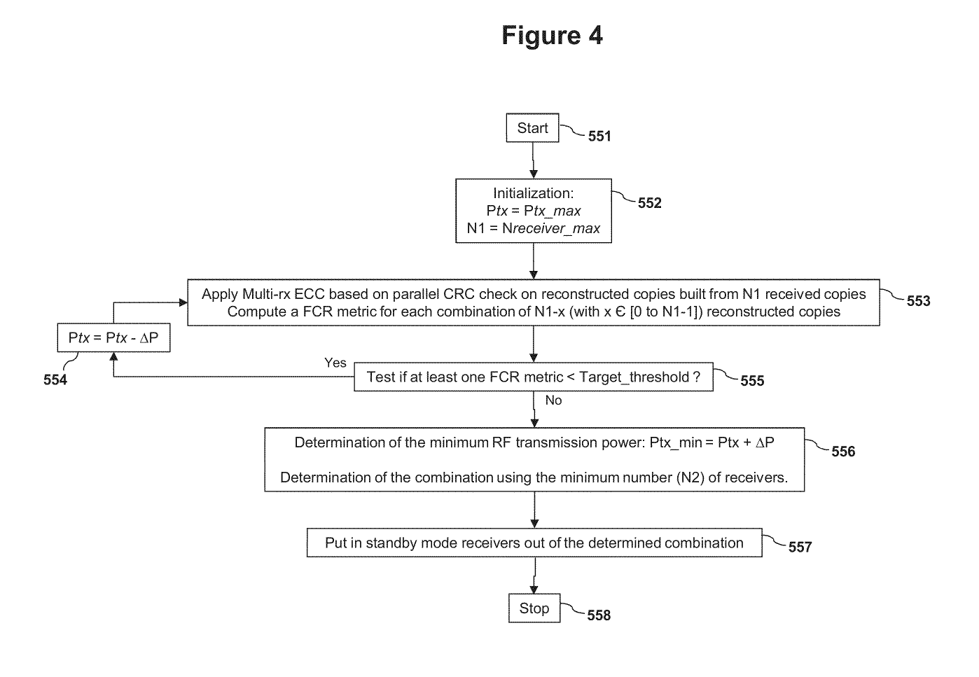

FIG. 4 represents the steps of an algorithm corresponding to a preferred embodiment of the present invention. For example this algorithm can be launched by the system controller node 16 when the emitter node 12 moves to a new position within the area 20.

In step 551 the system controller node 16 starts the algorithm.

In step 552 the system controller node 16 initializes the RF transmission power of emitter node 12 (Ptx) to the maximum RF transmission power (Ptx_max), it also initializes the variable N1 to the maximum number of receivers (Nreceiver_max).

In step 553 the system controller node 16 applies the preferred Multi-rx Error Correcting Code on the N1 received copies from the N1 receiver nodes 13, 14 and 15. For each received copy, the preferred Multi-rx ECC module performs a division into m sub-blocks. Then it concatenates the various sub-blocks to build N1^{m} reconstructed copies. Next, the preferred Multi-rx ECC module performs in parallel a CRC check on each reconstructed copy.

Then, the system controller node 16 computes a quality parameter, called False Check Rate (FCR), for different combinations of reconstructed copies corresponding to the different combinations of N1−x (with x ε [0 to N1−1]) received copies. The number of FCR metrics to compute is determined by the following equation:

$${N}_{F CR} = f ( N 1 ) = C ( \begin{matrix}N 1 - x \\ N 1\end{matrix} ) = \frac{N 1 !}{( N 1 - x ) ! ( N 1 - ( N 1 - x ) ) !}$$

For a given combination, the FCR metric is the ratio between the number of false CRC check and the total number of check for said combination at the output of the preferred Multi-rx ECC module.

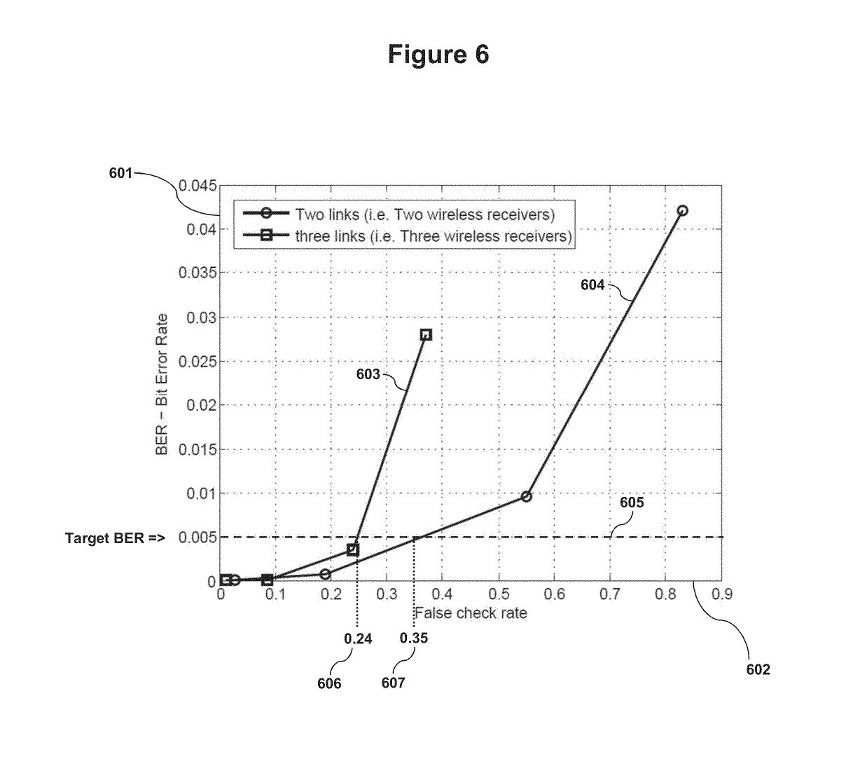

In step 555 each computed FCR metric is compared to its target quality parameter (Target_threshold), said target quality parameter being determined in accordance with the number of receivers used in the combination. The target threshold may be stored in memory, as a look up table for example, and may be determined as described in more detail in relation to FIG. 6 below.

The step 553 and 555 are performed iteratively for different values of RF transmission power as long as at least one computed FCR is lower than its target quality parameter. In this embodiment, the quality parameter is the FCR metric. For this particular FCR metric, the lower is its value, the higher is the reception quality.

If at least one FCR metric computed in step 553 is lower than its target quality parameter, the algorithm goes to the step 554. In the step 554, the system controller node 16 decreases the current RF transmission power (Ptx) by a predetermined value (ΔP) and sends the updated RF transmission power value to the emitter node 12. Then the algorithm loops to the step 553.

If none of the FCR metrics computed in step 553 is lower than its target quality parameter, the algorithm goes to the step 556. In step 556, the system controller node 16 determines and sends the minimum RF transmission power (Ptx_min) to be used by the emitter node 12. In step 556 the system controller node 16 optionally also determines the combination using the minimum number of receivers (N2) which FCR metric is lower than its target quality parameter.

In step 557, where a minimum number of receivers has been determined, the system controller node 16 sends control/command data to put in standby mode the receiver nodes outside the combination determined in step 557. In step 558 the algorithm is stopped.

This algorithm is not limitative and some variants may exist. For example, a variant of this algorithm could be to initialize the RF transmission power to a minimum and then to increase it by a predetermined value.

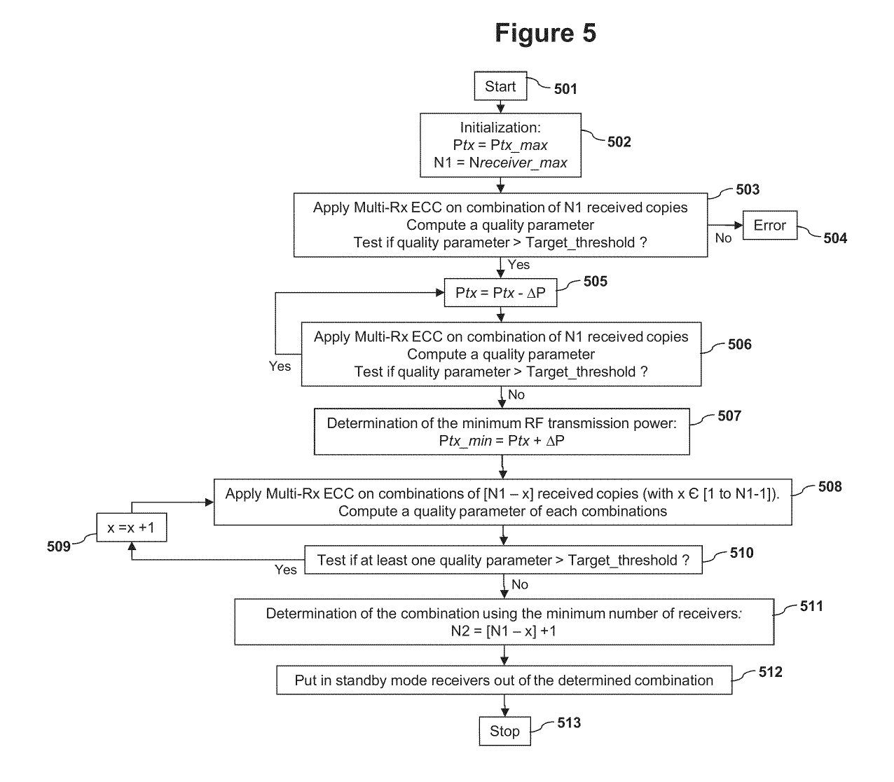

FIG. 5 illustrates a variation of the above method. According to the method shown in FIG. 5, transmission power and the minimum number of receivers are determined sequentially in separate iterative loops.

In step 501 the system controller node 16 starts the algorithm. In step 502 the system controller node 16 initializes the RF transmission power of emitter node 12 (Ptx) to the maximum RF transmission power (Ptx_max), it also initializes the variable N1 to the maximum number of receivers (Nreceiver_max).

In step 503 the system controller node 16 applies the Multi-rx Error Correcting Code on the combination of the N1 received copies from the N1 receiver nodes 13, 14 and 15. Next, a quality parameter, indicative of the quality of the decoding, is computed for the established combination. Then the computed quality parameter is compared to a target quality parameter (Target_threshold), said target quality parameter being determined for N1 receivers.

If the computed quality parameter is lower than the target quality parameter, the algorithm goes to the step 504. The step 504 corresponds to an error case. In this case, the system controller node is not able to recover the original copy of data sent by the emitter node 12. If the computed quality parameter is higher than the target quality parameter, the algorithm goes to the step 505. In step 505 the system controller node 16 decreases the current RF transmission power (Ptx) by a predetermined value (ΔP) and sends the updated RF transmission power value to the emitter node 12.

Then the algorithm goes to the step 506. The step 506 is similar to the step 503 described previously. The step 506 is performed iteratively for different values of RF transmission power as long as the computed quality parameter is higher than the target quality parameter. If the quality parameter computed in step 506 is higher than the target quality parameter, the algorithm loops to the step 505. If the quality parameter computed in step 506 is lower than the target quality parameter, the algorithm goes to the step 507. In step 507, the system controller node 16 determines and sends the minimum RF transmission power (Ptx_min) to be used by the emitter node 12. This RF transmission power (Ptx_min) will be used by the emitter node 12 for the remaining steps of this algorithm.

In step 508 the system controller node 16 applies the Multi-rx Error Correcting Code on the various combinations of N1−x (with x ε [1 to N1−1]) received copies from the N1−x receiver nodes. Next, a quality parameter, indicative of the quality of the decoding, is computed for each of the established combination. In step 510 each computed quality parameter is compared to its target quality parameter (Target_threshold), said target quality parameter being determined in accordance with the number of N1−x receivers used in the combination, as discussed below in greater detail.

If at least one quality parameter computed in step 508 is higher than its target quality parameter, the algorithm goes to the step 509. In the step 509, the variable x is increased by one. Then the algorithm loops to the step 508. If none of the quality parameters computed in step 508 is higher than its target quality parameter, the algorithm goes to the step 511. In step 511 the system controller node 16 determines the combination using the minimum number of receivers (N2) which quality parameter is higher than its target quality parameter.

In step 512 the system controller node 16 sends control/command data to put in standby the receiver nodes outside the combination determined in step 511. In step 513 the algorithm is stopped.

This algorithm is not limitative and some variants may exist. For example, a variant of this algorithm could be to initialize the RF transmission power to a minimum and then to increase it by a predetermined value.

FIG. 6 illustrates a relationship between false check rate (FCR) and bit error rate (BER). Such a relationship can be obtained by simulation, and represents the curves BER=f(FCR) for different number of receivers for the preferred embodiment of the invention.

The y-axis 601 indicates the Bit Error Rate (BER), the x-axis 602 indicates the False Check Rate (FCR). The curve 603 is the simulation result curve obtained for a number of 3 receivers. The curve 604 is the simulation result curve obtained for a number of 2 receivers. A possible target Bit Error Rate required by the application is indicated in 605.

The FCR threshold for 3 receivers corresponding to the target BER 605 is indicated in 606, as a value of 0.24. This FCR threshold 606 is used in the algorithm described in relation to FIG. 4 for example for the test of the computed FCR metric corresponding to the combination of 3 receivers.

The FCR threshold for 2 receivers corresponding to the target BER 605 is indicated in 607, as a value of 0.35. This FCR threshold 607 is used in the algorithm described in relation to FIG. 4 for example for the test of the computed FCR metrics corresponding to a combination of 2 receivers.

In embodiments of the invention the relevant threshold values for respective numbers of receivers can be stored, or alternatively the functions can be stored and appropriate values determined by calculation in response to a target BER.

It will be understood that the present invention has been described above purely by way of example, and modification of detail can be made within the scope of the invention.

Each feature disclosed in the description, and (where appropriate) the claims and drawings may be provided independently or in any appropriate combination.

1. A method for assessing reception quality of a common transmission by a set of receivers, said method comprising:
deriving a reception quality value for each of a plurality of different combinations of said set,
assessing each determined reception quality value against a threshold value which varies according to the number of receivers in the respective combination, and
determining, based on said assessment, whether the reception quality of at least one combination exceeds said threshold.

2. A method according to claim 1, further comprising using the result of said determination to control the transmission power of said transmission.

3. A method according to claim 2, comprising iteratively increasing said transmission power by a fixed amount in response to a negative determination.

4. A method according to claim 2, comprising iteratively decreasing said transmission power by a fixed amount in response to a positive determination.

5. A method according to claim 1, wherein for each combination of receivers, reconstructed data blocks are formed from combinations of sub blocks of copies of the same data block from respective receivers.

6. A method according to claim 1, wherein a reception quality value is determined by means of an error correction code.

7. A method according to claim 1, wherein a reception quality value is determined as the false check rate (FCR) of a combination of receivers.

8. A method according to claim 1, wherein said reception quality value is determined in dependence upon the distribution of transmission errors between different copies of data blocks of respective receivers making up a given combination.

9. A method according to claim 1, further comprising using the result of said determination to control the number of active receivers of said set.

10. A system controller for assessing reception quality of a common transmission by a set of receivers comprising:
an input unit configured to receive from each of a set of receivers data corresponding to said common transmission;
a data processing unit configured to combine, for each of a plurality of different combinations of receivers, data from the respective receivers, and calculate a quality parameter for each said combination based on said combined data;
a reference unit configured to provide a reference value which varies according to the number of receivers in a respective combination; and
an output unit configured to determine if at least one calculated quality parameter exceeds the relevant reference value, and to output an indication of reception quality for said set, based on said determination.

11. A system controller according to claim 10, wherein said data processing unit is configured to form reconstructed data blocks from combinations of sub blocks of copies of the same data block received from respective receivers.

12. A system controller according to claim 10, wherein said data processing unit is configured to calculate a quality parameter by means of an error correction code.

13. A system controller according to claim 10, wherein said data processing unit is configured to calculate the false check rate (FCR) of a combination of receivers.

14. A wireless network system comprising a transmitter node, a plurality of receiver nodes, and a system controller according to claim 10.

15. A wireless network system according to claim 14, wherein said system controller is configured to control the transmission power of the transmitter node in response to said indication of reception quality for said set.

16. A wireless network system according to claim 15, wherein said system controller is configured to iteratively increase said transmission power by a fixed amount in response to an indication that no calculated quality parameter exceeds the relevant reference value.

17. A wireless network system according to claim 15, wherein said system controller is configured to iteratively decrease said transmission power by a fixed amount in response to an indication that at least one calculated quality parameter exceeds the relevant reference value.

18. A wireless network system according to claim 14, wherein said system controller is configured to control the number of active receivers of said plurality.
